(19) United States
(12) Patent Application Publication
(10) Pub. No.: US 2020/0248930 A1
(43) Pub. Date: Aug. 6, 2020

(54) METHOD AND APPARATUS FOR MOUNTING PANELS

(71) Applicant: Barry Jon Kimble, Vista, CA (US)

(72) Inventor: Barry Jon Kimble, Vista, CA (US)

(21) Appl. No.: 16/779,061

(22) Filed: Jan. 31, 2020

Related U.S. Application Data
(60) Provisional application No. 62/799,293, filed on Jan. 31, 2019.

(51) Int. Cl. F24S 25/636; F24S 25/35

(52) U.S. Cl. CPC F24S 25/636; H02S 20/23; F24S 25/35

(57) ABSTRACT

A solar racking clamp and bracket eliminates the need for special clamps used with proprietary rails systems common in current solar panel installation designs. The racking clamp allows for the use of this clamp with common tubular pipe. Common pipe can be found in locally in first and third world countries. This invention has the ability to bring solar to more places due to the simplicity in design and ease of installation.

### CROSS-REFERENCE TO RELATED APPLICATION

This application claims the benefit of priority of U.S. provisional application No. 62/799,293, filed Jan. 31, 2019, the contents of which are herein incorporated by reference.

### BACKGROUND OF THE INVENTION

The present invention relates to installation hardware, and more particularly to installation hardware for mounting items, such as a solar panel, to a pipe or cylindrical structure.

For many years, existing solar mounting systems have been installed using proprietary strut. These proprietary strut based systems are expensive to manufacture and procure. There are currently a large number of manufacturers making their own proprietary strut based systems which, by their very nature, are not interchangeable. This can often make installing solar systems difficult, time consuming and more expensive than necessary. In the case where the installer has miscalculated his/her strut needs and needs to get more proprietary strut on an urgent basis the project will be delayed if there is no local stock available. If the installer needs the material air freighted in the cost of the freight will be excessive because of the length of the strut.

Another limitation of current strut based systems for mounting solar panels is the exasperating proliferation of and excessive number of proprietary parts for attaching the panels to the strut and the strut to the roof-mounting device. These proprietary parts are, by design, not inter-changeable and are often different designs for different sized modules and rails. This leads to a large number of different rails and non-interchangeable parts that require a unique combination of parts based on the solar panels that are provided.

As can be seen, there is a need for an improved hardware clamp that eliminates the need for special clamps used with proprietary rail mounting structures common in current designs and allows for the use of this clamp with common tubular pipe.

### SUMMARY OF THE INVENTION

In one aspect of the present invention, a clamp for mounting a panel to a pipe carried by a support structure is disclosed. The clamp includes a clamp body having a circumferential sidewall and an interior diameter dimensioned to receive the pipe therein. A plurality of apertures are radially disposed in a spaced apart relationship about the circumferential sidewall. The plurality of apertures are adapted to receive a fastener to secure the clamp to one or more of the pipe and the panel.

In some embodiments, the clamp body also includes a plurality of clamp segments. A pivot joins the plurality of clamp segments. A joining face is disposed opposite the pivot and are oriented for cooperative engagement when the clamp is secured about the pipe. A joining aperture is configured to receive a joining fastener through the joining face to retain the plurality of clamp segments around the pipe.

In some embodiments, the fastener includes a bolt threadingly engaged through one or more of the apertures for securement against an outer surface of the pipe. In other embodiments, the fastener includes a stud engaged with one or more of the apertures. The stud is adapted to receive a bracket for interconnection with one or more of the pipe, a mount, and the panel.

In other embodiments, a rear attachment plate is disclosed. The rear attachment plate includes a bridge interconnecting a proximal end of a first and a second plate finger. A bridge aperture is defined through the bridge for receiving a stud attachment to at least one of the plurality of apertures of the clamp. An attachment aperture is defined at a distal end of each of the first and the second plate finger. The attachment aperture may be a slotted aperture.

In other embodiments, a mount interface surrounds one or more of the plurality of apertures. The mount interface has a face to orient the clamp at a desired alignment between the panel and the support structure. In some embodiments, each mount interface is orthogonally disposed relative to an adjacent mount interface. In other embodiments, at least two mount interfaces are disposed in a 180 degree orientation relative to each other.

These and other features, aspects and advantages of the present invention will become better understood with reference to the following drawings, description and claims.

### BRIEF DESCRIPTION OF THE DRAWINGS

FIG. 1 is a perspective view of the invention, shown in an exemplary structure installation.

FIG. 2 is a perspective view of a clamp 10.

FIG. 3 is a perspective view of the clamp 10 with stud 18 in place for an exemplary installation with an end bracket 24 and mounting plate 28.

FIG. 4 is a detail perspective view of a mid bracket 25.

FIG. 5 is an exploded view of the invention, including end bracket 24 and mid bracket configuration options.

FIG. 6 is a section view of the invention, taken along line 6-6 in FIG. 1.

FIG. 7 is a section view of the invention, taken along line 7-7 in FIG. 1.

FIG. 8 is a perspective view of rear attachment plate 40.

FIG. 9 is a bottom perspective view of plate 40, shown in an exemplary installation.

FIG. 10 is a perspective view of a ground mounted installation of panels using plates 40.

FIG. 11 is a perspective view of an alternate embodiment of the clamp for mid-pipe placement.

FIG. 12 is a perspective view of an alternate embodiment of the clamp, illustrating the opening of upper segment 56.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

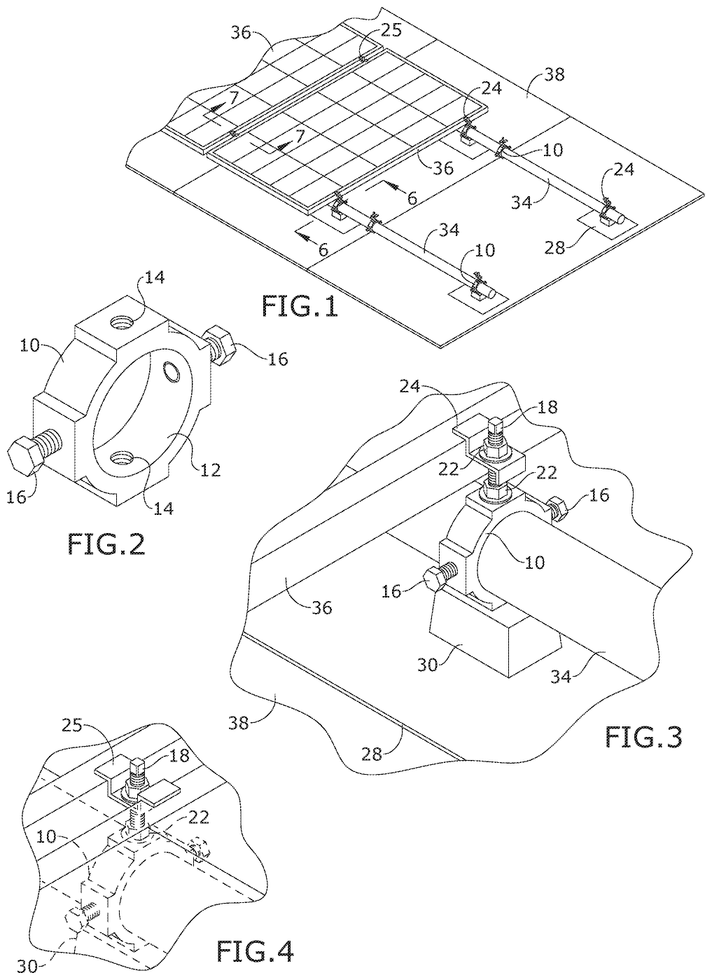

Broadly, embodiments of the present invention provide apparatus to a clamp and a method of utilizing this clamp to attach items, such as a solar panel to a common pipe. As seen in reference to FIG. 1, a clamp 10 according to aspects of the invention is utilized to secure a photovoltaic panel 36 to one or more pipes 34, which are secured via a quick mount plate 38 to a supporting structure 38, such as a roof of a building or other structure. The pipes 34 may be configured for a predetermined number of photovoltaic panels 36 and may also be configured to accommodate additional capacity with the addition of additional photovoltaic panels 36 at a later time. While the present invention is described in the context of solar panel installations to quickly mount and secure one or more photovoltaic panels 36 in a solar array onto common pipe 34, the full scope of the invention is not so limited and may be utilized in the mounting of other panel structures.

As seen in reference to the drawings, the pipe 34 that support the photovoltaic panel 36 may be mounted to a support structure 38, in the case of a building, or to a ground mounted structure 50 in the case of a ground-mounted photovoltaic array. The present invention is particularly, but not exclusively useful for attaching photovoltaic panels 36. As will be appreciated with the benefit of the present disclosure, it might also be useful for mounting signage or other devices to roofs, parking structures or other ground-mounted structures.

The clamp 10 allows the use of common tubular pipe 34 for the mounting of solar panels 36. The clamp 10 eliminates the need for proprietary clamps that are necessary for use with proprietary rail structures and makes the installation of a photovoltaic solar panels 36 less complicated and quicker.

Each solar panel mounting system in the prior art has multiple parts that are not interchangeable from one design to another design. This makes installation more difficult for the installer, should they make a mistake on their parts estimate or design layout. In the event of a miscalculation the installer faces steep freight charges for the special clamps and especially for the proprietary rail that is usually 10′ or 20′ in length.

As indicated, aspects of the present invention eliminate the need for special clamps used with proprietary rail structures common in current designs and instead allows for the use of the clamp 10 with common tubular pipe 34. The common pipe 34 can be found and sourced locally in first through third world countries. This invention has the ability to bring solar energy to more places due to the simplicity in design and ease of installation.

As seen in reference to FIG. 2, an embodiment of the base clamp 10 is shown. The clamp 10 has a body with a circumferential sidewall that has a central aperture with an interior sidewall 12 that is dimensioned to loosely attached to the pipe 34 by sliding the clamp 10 over the end of the pipe 34. The clamp 10 has a plurality of apertures 14, preferably threaded, extending through the sidewall of the clamp 10. The plurality of apertures 14 are radially disposed in a spaced apart relation about a circumference of the clamp 10. The spaced apart relation may be according to a desired orientation between the mounting structure and the photovoltaic panel 36. Preferably, the plurality of apertures are disposed orthogonal to one another about the circumference of the clamp. While shown as a circular structure about the central aperture, the body of the clamp 10 may also be formed as a block structure.

The apertures 14 receive a fastener, such as a bolt 16 or a mounting stud 18, for securing the clamp 10 to the pipe 34 or other mounting structures 30, 28 to couple the pipe 34 to a supporting structure 38. A mount interface surface 15 may surround each of the plurality of apertures 14 to each having a face to orient the clamp 10 at a desired alignment between the photovoltaic panel 36 and one or more of the roof mount 30 and the support base 28.

As seen in reference to FIG. 3, the clamp 10 is firmly affixed to the pipe 34 when the fastener 16 is tightened onto the pipe 34. Tightening of the fastener 16 is accomplished with the use of the non-threaded square, hexagonal, or other shaped tool engagement end. In FIGS. 3 and 4, a photovoltaic panel 36 is attached to the clamp 10 utilizing an end bracket 24 and a mid-bracket 25 that are mounted on the stud 18 and secured at a desired vertical clearance via a nut 22. The stud 18 being of sufficient length that it can be utilized with standard solar panels of varying depths utilizing existing end 24 and mid brackets 25, depending on the position at which the photovoltaic panel 36 is being attached. The stud 18 may a squared off tool engagement end so that it can also be used to tighten the clamp 10 against the outer surface of the pipe 34. These end 24 and mid-brackets 25 are commercially available and may be utilized with the present invention to attach to a frame member of the photovoltaic panel 36.

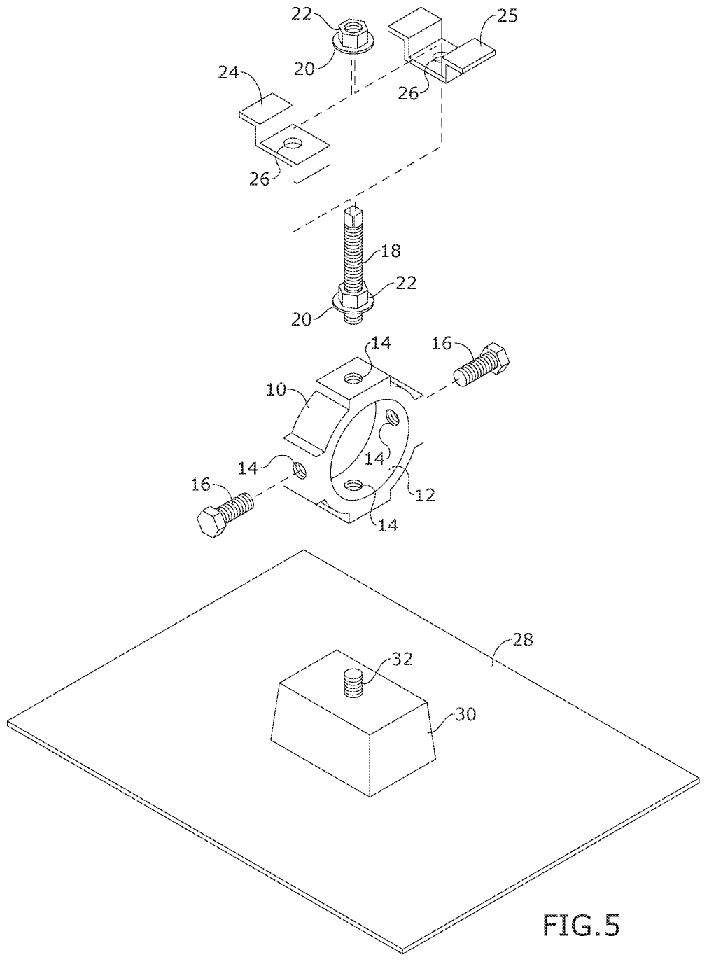

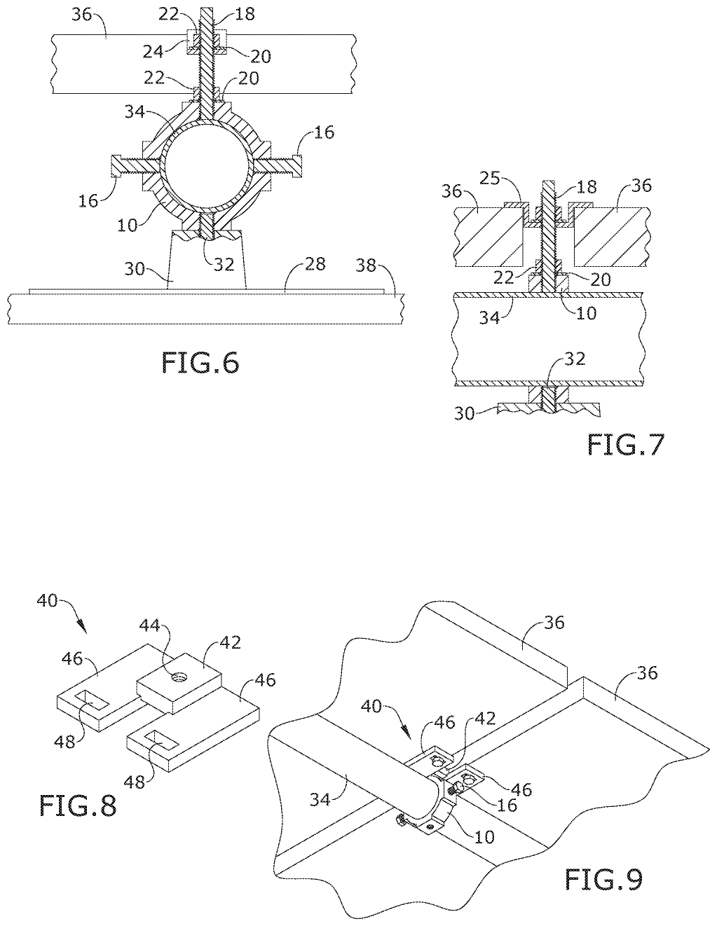

As seen in reference to FIGS. 1 and 3-6, the clamp 10 is attached to the supporting structure 28 by attachment to a commercially available roof mount 30. This is accomplished by receiving a post 32 extending from the roof mount 30 via a threaded, or non-threaded aperture 14 in the clamp 10. The roof mount 30 is also commercially available and may also be utilized with the present invention.

As seen in FIGS. 8-10 a rear attachment plate 40 can be utilized when the system is arrayed in a ground mounted condition and in those installations providing access to the rear of the photovoltaic array 36 for an easier installation.

FIG. 8 shows a rear attachment plate 40 having a bridge 42 interconnecting a left and a right plate finger 46. Slotted apertures 48 are provided at a distal end of the left and the right plate finger 46 for attachment to a back surface of the photovoltaic panel 36. A threaded aperture 44 is provided on a front surface of the bridge 42 to receive a fastener 16, 18 for attachment to one of the plurality of apertures 14 of the clamp 10.

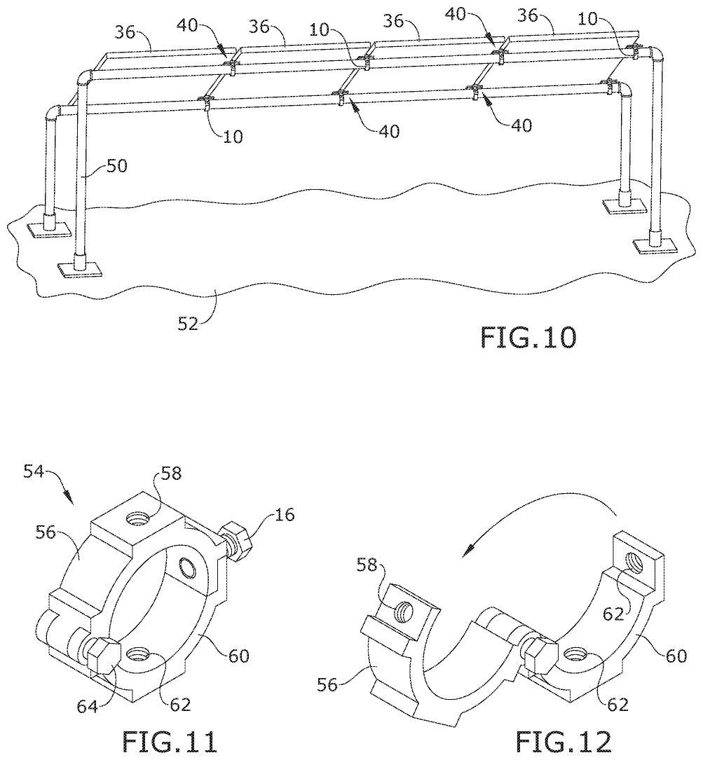

FIGS. 9 and 10 illustrate a typical ground supported installation in which the photovoltaic panels 36 are supported on a plurality of upstanding posts 50 with pipes 34 interconnecting the plurality of upstanding posts 50. In this case a back surface or frame member of the photovoltaic panel 36 rests on the fingers 46 of the rear attachment plate 40. Fasteners 16 are received through the apertures 48 to secure the rear attachment plate 40 to the photovoltaic panel 36.

A split clamp 54 is illustrated in reference to FIGS. 11 and 12. The split clamp 54 has a plurality of segments 56, 60 defining the circumferential wall of the clamp 10. As with the unitary clamp 10, a plurality of apertures 62, 58 are provided for receiving a fastener for securement of the split clamp 54 to the pipe 34. A pivot 64 is provided between the plurality segments at one side of the split clamp 54. A joining face is defined on each of the plurality of segments, opposite the pivot 64. The face of each of the plurality of segments overlap each other in a closed condition about the pipe 34. A joining aperture extends through each joining face for securement of the plurality of segments in the closed condition to encircle the pipe 34.

The split clamp 54 are particularly useful in the event that the installer breaks a base clamp 10 or by his or her error needs additional clamps 10 to the pipe 34, after the ends of the pipe have been installed. The split clamp 54 can be utilized without disturbing the installed photovoltaic panel 36 array or cutting the pipes 34 that the clamps 10 slide onto.

In the case of a roof mounted solar array having a plurality of photovoltaic panels 36, the system utilizes a clamp 10, 54 which have an inside diameter that is slightly larger than the outside diameter of the pipe 34 on which it will be mounted. The clamps 10, 54 have multiple apertures where a stud 18 or bolt 16 is turned through the clamp 10, 54 to provide the clamping force necessary to prevent the clamp 10, 54 from shifting on the pipe 34. The clamp 10, 34 have a flat face with a threaded apertures that allow the clamps 10, 54 to be mounted to a roof via a roof support system, such as the one in U.S. Pat. No. 6,360,491 issued to Ullman or in U.S. Pat. No. 7,762,027 issued to Wentworth et al.

In the instance where the clamp 10, 54 is located between two photovoltaic panels 36, a Mid Clamp bracket 25 such as disclosed in Prior Art—U.S. Pat. No. 3,443,350 with fins that clamp on to two photovoltaic panels 36 to prevent their movement once the mid clamp device bracket 25 is tightened down on the top mounted stud 18.

In the instance where the clamp 10, 54 is located at the end of a panel array, an End Clamp bracket 24, such as shown in Prior Art patent U.S. Pat. No. 3,443,350 is tightened on the stud to prevent movement of the photovoltaic panel 36.

In the case of a ground mounted array shown in FIG. 8, the system may utilize the same clamp 10, 54 which has an inside diameter that is slightly larger than the outside diameter of the pipe 34 on which it will be mounted. The clamp 10, 54 may have multiple points where a stud 18 or bolt 16 is turned through the clamp to provide the clamping force necessary to prevent the clamp 16 from shifting on the pipe 34.

In FIG. 9, the base clamp has a flat bottom face with a threaded hole that allows the clamp to be mounted to the rear attachment plate 40. The rear attachment plate 40 may be affixed onto the clamp 10 with a bolt. In FIG. 10, the solar panels 36 are attached to the Rear attachment plate via holes on the rear frame of the panels 36. Screws and nuts 22 may be utilized to tighten the solar panel 36 to the rear attachment plate 40.

The clamp 10 could be manufactured with extruded aluminum and cut to individual pieces or cast with various metals. Likewise, the split clamp 54 may be made in two pieces and fixed together via a bolt and nut or similar fastener. The rear attachment plate 40 may be manufactured in a similar fashion and could also be cast.

The simplicity of the design allows for use of a single clamp 10 with common pipe 34 for the installation of the photovoltaic panels 36. This negates the need for proprietary systems that are expensive and not commercially available in all locales. A device for securing wire might me attached or be built into the clamp. Similarly, a hole might be drilled and tapped in the device to allow for a ground wire to be passed through the clamp for system grounding.

The base clamp 10 along with its components—Either the rear attachment plate 40 or the front mounting stud 18—along with the two piece variant could be used for attaching many different types of items to common pipe 34. The clamp 10, 54 of the present invention could also be utilized in other mounting situations to include signage, thermal panels, and other flat panels, such as video displays.

Therefore, a previously unaddressed need exists in the industry for a new and useful device for attaching solar panels to a roof or ground mounted structure via common, and readily available pipe 34.

The present invention relates to the solar industry and specifically to mounting photovoltaic solar panels 36 to a pair of common pipes 34. The pipes 35 may be mounted to a roof 38 in the case of a building or parking structure or to the ground via a ground-mounted structure 50.

The common pipe 34 replaces the proprietary rails utilized in current photovoltaic panel 36 installations. The present invention is universal in nature and is capable of securing the majority of the solar panels 36 on the market to common pipe 34 and thus the number of parts needed by an installer are greatly reduced.

The present invention allows an installer to utilize a single clamp 10 when mounting photovoltaic panels 36 from the front or the rear of a support structure. All that the user needs to do is add the stud 18 with the selected mid 25 or end bracket 24 for mounting from the front or add the rear mounting plate 40 for mounting from the rear of the photovoltaic panel 36. This mounting system is elegant in its simplicity but sophisticated in its design.

It should be understood, of course, that the foregoing relates to exemplary embodiments of the invention and that modifications may be made without departing from the spirit and scope of the invention as set forth in the following claims.

What is claimed is:

1. A clamp for mounting a panel to a pipe carried by a support structure, comprising:
a clamp body having a circumferential sidewall and an interior diameter dimensioned to receive the pipe therein;
a plurality of apertures radially disposed in a spaced apart relationship about the circumferential sidewall; and
the plurality of apertures adapted to receive a fastener to secure the clamp to one or more of the pipe and the panel.

2. The clamp of claim 1, wherein the clamp body further comprises:
a plurality of clamp segments; and
a pivot joining the plurality of clamp segments.

3. The clamp of claim 2, wherein the clamp body further comprises;
a joining face disposed opposite the pivot oriented for cooperative engagement when the clamp is secured about the pipe; and
a joining aperture configured to receive a joining fastener to retain the plurality of clamp segments around the pipe.

4. The clamp of claim 1, wherein the fastener includes a bolt threadingly engaged through one or more of the apertures for securement against an outer surface of the pipe.

5. The clamp of claim 1, wherein the fastener includes a stud engaged with one or more of the apertures, the stud adapted to receive a bracket for interconnection with the one or more of the pipe and the panel.

6. The clamp of claim 1, further comprising:
a rear attachment plate having a bridge interconnecting a proximal end of a first and a second plate finger, a bridge aperture for receiving a stud for attachment to at least one of the plurality of apertures of the clamp; and
an attachment aperture at a distal end of each of the first and the second plate finger.

7. The clamp of claim 6, wherein the attachment aperture is a slotted aperture.

8. The clamp of claim 1, further comprising:
a mount interface that surrounds one or more of the plurality of apertures, the mount interface having a face to orient the clamp at a desired alignment between the panel and the support structure.

9. The clamp of claim 8, wherein each mount interface is orthogonally disposed relative to an adjacent mount interface.

10. The clamp of claim 8, wherein at least two mount interfaces are disposed in a 180 degree orientation relative to each other.
